(19) United States
(12) Patent Application Publication
(10) Pub. No.: US 2019/0277073 A1
(43) Pub. Date: Sep. 12, 2019

(54) HINGE ASSEMBLY FOR FLOOD GATES

(71) Applicant: M3 GLOBAL FLOOD TECHNOLOGIES LIMITED, West Sussex (GB)

(72) Inventor: Frank KELLY, Droitwich Worcestershire (GB)

(73) Assignee: M3 GLOBAL FLOOD TECHNOLOGIES LIMITED, West Sussex (GB)

(21) Appl. No.: 16/343,737

(22) PCT Filed: Oct. 17, 2017
(86) PCT No.: PCT/EP2017/076513

§ 371 Date: Apr. 19, 2019

(30) Foreign Application Priority Data
Oct. 26, 2016 (GB) 1618054.9

(51) Int. Cl. E05D 3/02; E05D 5/02; E05D 7/04; E05D 7/00

(52) U.S. Cl. CPC E05D 3/02; E05D 5/02; E05D 7/0415; E06B 2009/007; E05D 2007/0036; E05D 2007/0492; E05D 7/0027

(57) ABSTRACT

A hinge assembly for a flood gate comprises support means (1) provided with a first projecting portion (5); a hinge housing (9) having a base plate (11) formed with an aperture (13) for receiving the first projecting portion (5) of the support means (1), with a second projecting portion (21), and with a third projecting portion (15) provided with an aperture (13) receiving a hinge pin. Adjusting means (27, 28) acts between the first and second projecting portions (5,21) and threadingly engages with one thereof. The adjusting means (27,28), the support means (1), and the hinge housing (9) are configured such that rotation of the adjusting means (27,28) in one direction causes movement of the hinge housing (9) relative to the support means (1) in a first direction and such that rotation of the adjusting means (27,28) in the other direction causes movement of the hinge housing (9) relative to the support means (1) in a second direction opposite to the first axial direction. Hinge arm adjusting means (31) is threadingly mounted in the third projecting portion (15) such that rotation of the adjusting means (31) in one direction moves the adjusting means (27,28) in a third direction and rotation of the adjusting means (31) in the other direction moves the adjusting means (31) in a fourth direction opposite to the third direction. The hinge arm adjusting means (31) is adapted in use to engage with a hinge arm (37) so as to raise or lower the height of the hinge arm (37) within the hinge housing (9), the third and fourth directions being perpendicular to the first and second directions.

This invention relates to a hinge assembly for use in particular with flood gates.

Flood gates are generally made of steel and swing horizontally (i.e., about a vertical axis) either with manual operation or by way of hydraulic or electrical power. Dependent upon size and weight, together with variable factors such as weather and other local conditions, such flood gates can generally be operated by a single person.

Known flood gates suffer a number of drawbacks, for example relating to usability, adjustment and sealing of the gate. Some gates can require considerable force to move and lock them in position to ensure a flood-tight seal. The weight of larger flood gates, especially those for industrial purposes, can cause the gates to drop over larger spans, resulting in the gates catching or requiring to be lifted into position to create an adequate seal.

It is therefore an object of the present invention to provide a hinge assembly for a flood gate which overcomes, or at least ameliorates the above-mentioned problems.

According to the present invention there is provided a hinge assembly for a flood gate, the hinge assembly comprising: support means provided with a first projecting portion; a hinge housing having a base plate formed with an aperture for receiving the first projecting portion of the support means, with a second projecting portion, and with a third projecting portion provided with an aperture receiving a hinge pin; adjusting means acting between the first and second projecting portions and threadingly engaging with one thereof, the adjusting means, the support means, and the hinge housing being configured such that rotation of the adjusting means in one direction causes movement of the hinge housing relative to the support means in a first direction and such that rotation of the adjusting bar in the other direction causes movement of the hinge housing relative to the support means in a second direction opposite to the first axial direction; and hinge arm adjusting means threadingly mounted in the third projecting portion such that rotation of the adjusting means in one direction moves the adjusting means in a third direction and rotation of the adjusting means in the other direction moves the adjusting means in a fourth direction opposite to the third direction, the hinge arm adjusting means being adapted in use to engage with a hinge arm so as to raise or lower the height of the hinge arm within the hinge housing, the third and fourth directions being perpendicular to the first and second directions.

The support means may be provided with a plurality of apertures for the passage of securing means. Four apertures may be provided, for example arranged at the corners of a square.

The first projecting portion of the support means may comprise two laterally spaced projections, for example in the form of two bars. The bars may include flat portions which in use extend vertically and are opposed to and extend parallel to each other, the bars being spaced horizontally relative to each other.

The base plate of the hinge housing may be formed with a plurality of slotted apertures to allow for the passage of securing means while permitting lateral adjustment of the housing relative to the securing means. The slotted apertures may be positioned at the corners of a square. The slotted apertures may each coincide with a respective one of the apertures of the support while allowing lateral movement of the hinge housing relative to the support.

The second projecting portion of the hinge housing may comprise two spaced projecting portions.

The adjusting means may comprise a bolt, for example having a hexagonal head, threaded through apertures in one of the first projecting portion of the support means and the second projecting portion of the housing, preferably through apertures through the second projecting portion of the housing and engaging against the first projecting portion of the support means.

The second projecting portion of the hinge housing may comprise two spaced side plates which extend vertically in use, for example from opposing side edges of the base plate.

The third projecting portion may comprise two spaced projecting portions, the two projecting portions being positioned spaced one above the other in use. The two projections forming the third projecting portion may be provided with coaxial apertures receiving the hinge pin, the axial direction of the apertures in the first and second projecting portions being perpendicular to the axial direction of the apertures in the projecting portions of the third projecting portion.

The projecting portions of the third projecting portion may comprise two hinge pin support plates which extend horizontally in use from the back plate, one above the other and spaced apart by a sufficient distance so as to be spaced above and below the aperture for the first projecting portion. A spacer plate may extend vertically in use between the two hinge pin support plates and may be secured to each of the plates. The spacer plate may be positioned a sufficient distance from the back plate to be located in use beyond the end of the first projecting portion.

The side plates of the hinge housing may extend above and below the hinge pin support plates and may be formed with cut-outs located between the support plates and extending rearwardly from free edges of the side plates to the spacer plate. The side plates may be secured to the edges of the hinge pin support plates and to the spacer plate. The side plates may each be formed with an aperture, the apertures in the side plates being coaxial with the aperture in the first projecting portion.

The hinge pin may have a head which bears against the upper surface of the upper support plate and in its lower region extends through the hinge arm adjusting means.

Rotation of the hinge arm adjusting means in the lower hinge pin support plate may raise or lower an upper annular surface of the hinge arm adjusting means, depending on the direction of rotation, in the space between the two hinge pin support plates.

The hinge pin may be mounted in the upper support plate by way of a bearing, for example a non-grease bearing, and may be mounted in the hinge pin adjusting means by way of a further bearing, for example a further non-grease bearing.

The hinge housing may be provided with cover plates, for example with upper and lower cover plates. The cover plates may protect the hinge assembly and act as a security measure to prevent tampering with the adjustable components of the hinge assembly.

For a better understanding of the present invention and to show more clearly how it may be carried into effect reference will now be made, by way of example, to the accompanying drawings in which:

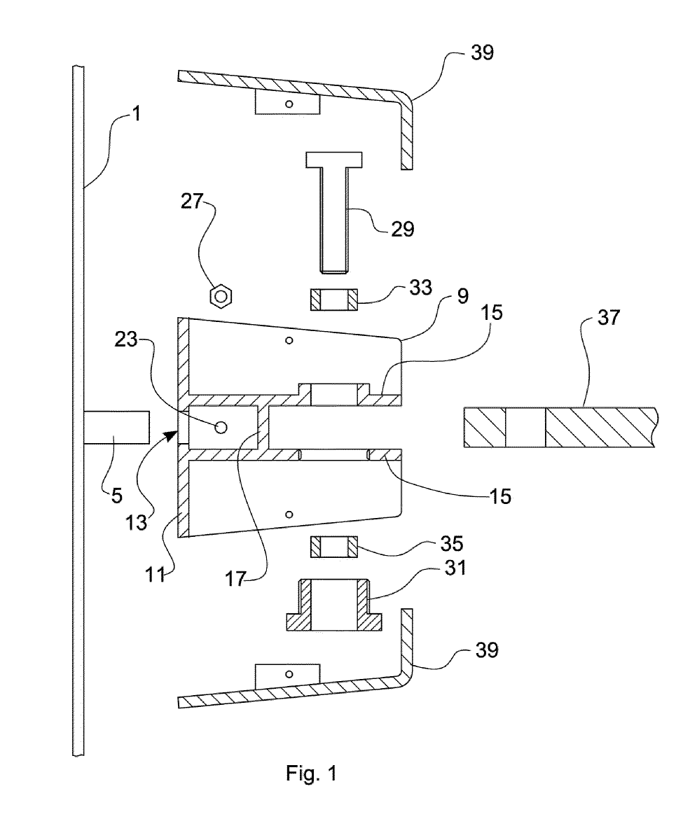

FIG. 1 is an exploded plan view of one embodiment of a hinge assembly for a flood gate in accordance with the present invention;

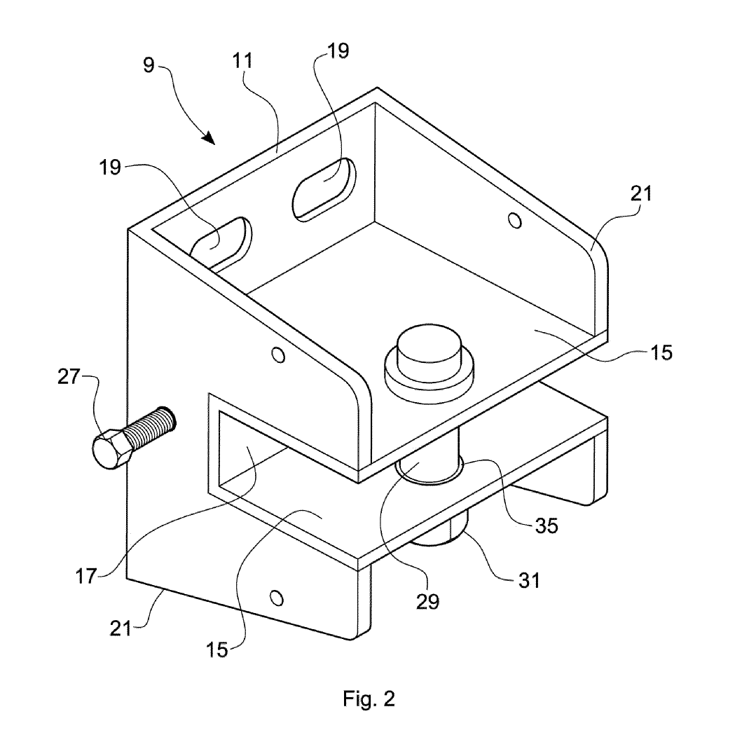

FIG. 2 is a front perspective view of part of the hinge assembly shown in FIG. 1;

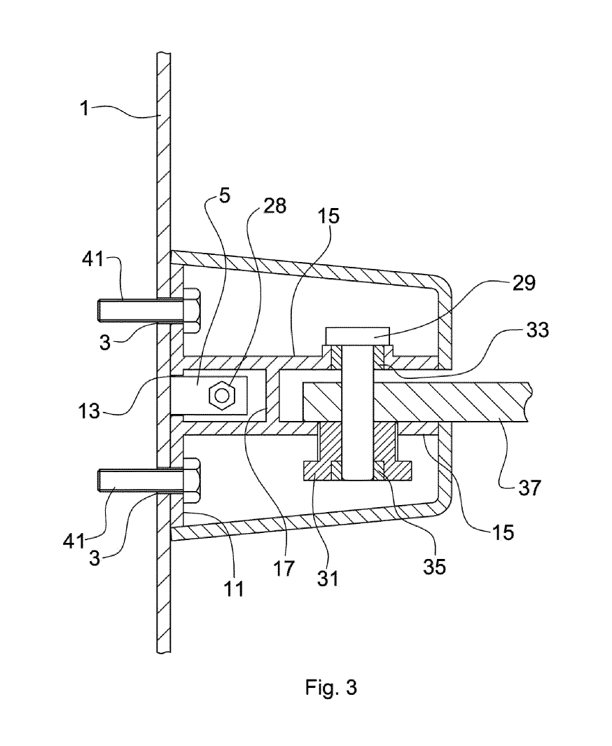

FIG. 3 is a side view of part of the hinge assembly shown in FIG. 1; and

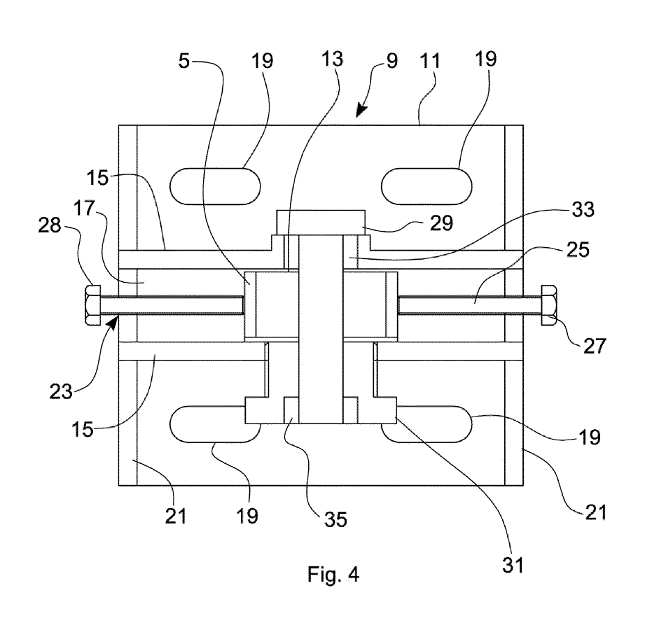

FIG. 4 is a front view of part of the hinge assembly shown in FIG. 1.

The figures show a hinge assembly for a flood gate, the hinge assembly comprising a support means in the form of a frame 1 which in use is mounted to a surface and which includes four apertures 3 for the passage of securing means and which are arranged substantially at the corners of a square. Two bars 5 protrude from the frame 1 in a direction perpendicular to the plane of the frame to provide the first projecting portion, the bars including flat portions which extend vertically and are opposed to and extend parallel to each other, the bars being spaced horizontally (in use) relative to each other. The centre of mass of the two bars coincides with the centre of mass of the four apertures 3.

The hinge further comprises a housing 9 which comprises a back plate 11 which is vertical in use and is formed with an aperture 13 therein for the passage of the two bars 5. Top and bottom hinge pin support plates 15 extend horizontally in use from the back plate, one above the other and spaced apart by a sufficient distance so as to be spaced above and below the aperture 13 and the bars 5, to provide the third projecting portion. A spacer plate 17 extends vertically in use between the top and bottom hinge pin support plates 15 and is secured to each of the plates so as to reinforce the hinge pin support plates and maintain the plates at a constant spacing. The spacer plate 17 is positioned a sufficient distance from the back plate 11 to be located in use beyond the ends of the bars 5 when the bars extend through the aperture 13. The back plate 11 is provided with four fixing slots 19 which extend horizontally in use and are arranged substantially at the corners of a square. The fixing slots 19 each coincide with a respective one of the apertures 3 of the frame 1 while extending laterally each side of the apertures 3 to allow lateral movement of the housing relative to the frame.

The housing 9 also includes two side plates 21 which extend vertically in use from opposing side edges of the back plate 11 to provide the second projecting portion of the hinge housing. The side plates extend above and below the hinge pin support plates 15 and are formed with cut-outs located between the support plates 15 and extending rearwardly from free edges of the side plates to the spacer plate 17. That is, the cut-out in each side plate 21 is substantially rectangular. The side plates 21 are secured to the edges of the hinge pin support plates and to the spacer plate 17 to further reinforce the hinge pin support plates 15. The side plates are each formed with an aperture 23.

A bolt 27, 28, for example having a hexagonal head, is threaded through each of the apertures 23 with the head of each bolt positioned externally of the side plate of the housing and the free end of each bolt engaging against a respective one of the bars 5. As one of the bolts 27, 28 is rotated in one sense and the other of the bolts is rotated in the opposite sense, the housing is moved with respect to the frame 1 in one lateral direction. If the direction of rotation of the two bolts is reversed than the housing is moved with respect to the frame in the opposite lateral direction. This arrangement provides for lateral adjustment of the housing 9 relative to the frame 1.

Alternative ways are possible for adjusting the housing laterally with respect to the frame. For example, the apertures 23 may be plain and the two bolts may be threaded into apertures in the bars 5.

A hinge pin 29 extends vertically in use between the two hinge pin support plates 15 and effectively extends through apertures provided in the plates 15. The hinge pin has a head which bears against the upper surface of the upper support plate and in its lower region extends through an adjustment bolt 31 which is externally threaded to engage in a threaded aperture in the lower hinge pin support plate, the adjustment bolt providing the hinge arm adjusting means. Rotation of the adjustment bolt in the lower hinge pin support plate raises or lowers an upper annular surface of the adjustment bolt, depending on the direction of rotation, in the space between the two hinge pin support plates. The hinge pin 29 is mounted in the upper support plate by way of a bearing 33, for example a non-grease bearing, and is mounted in the adjustment bolt 31 by way of a further bearing 35, for example a further non-grease bearing. Non-grease bearings allow the housing 9 to be submerged without the need for re-greasing, thereby reducing the need for servicing. A hinge arm 37 which in use is secured to a flood gate (not shown) is rotatably mounted about the hinge pin 29, for example by way of another non-grease bearing, and extends out of the space between the two hinge pin support plates 15.

The housing 9 is further provided with upper and lower cover plates 39 which protect the hinge assembly and act as a security measure to prevent tampering with the adjustable components of the hinge assembly.

In use of the hinge assembly according to the present invention, the frame 1 is set in a suitable surface, such as a wall. In practice, a number of frames are spaced apart in the surface vertically above each other so as to provide multiple support points for a flood gate or a single frame 1 provides multiple support points for the flood gate. A housing 9, with cover plates 39 removed, is attached to each frame 1 by means of four bolts 41 which pass through the horizontal fixing slots 19 in the housing and through the apertures 3 in the frame to be secured in the surface, but the bolts are not fully tightened so as to allow the housing to be adjusted laterally relative to the frame. The bolts 27, 28 are each threaded through the respective aperture 23 so as to engage against the respective bar 5, and the heads 27, 28 are rotated to adjust the housing 9 laterally to the left or to the right with respect to the frame 1.

Once the housing has been adjusted to a desired lateral position relative to the frame 1, the bolts 41 can be tightened to secure the housing in that position relative to the frame. This allows a flood gate to be moved to the left or right for adjustment purposes, but to be locked in a desired position so that no undesired movement can take place even as a result of the heavy flood gate locking into place.

The height of the hinge arm 37 can also be adjusted upwardly and downwardly by rotation of the adjustment bolt in the lower hinge pin support plate until the hinge arm is at a desired position between the hinge pin support plates. Vertical adjustment of the flood gate allows a desired seal/compression to be created at the threshold of the flood gate to prevent the passage of flood water.

Once the housing 9 and hinge arm 37 are in their desired positions, the cover plates 39 can be mounted on the housing to protect the hinge assembly and to act as a security measure to prevent tampering with the adjustable components of the hinge assembly.

Adjustment of the housing and hinge arm allows the position of a flood gate to be “toed and heeled” so that the gate sits correctly and sits evenly over the length of the threshold and uprights. This is important because a 1 degree error over a flood gate width of 4 metres would result in a 70 mm drop over the width of the flood gate. Lateral adjustment also allows compensation for any error in alignment of the frame or frames 1.

1. A hinge assembly for a flood gate, the hinge assembly comprising: support means (I) provided with a first projecting portion (5); a hinge housing (9) having a base plate (11) formed with an aperture (13) for receiving the first projecting portion of the support means, the hinge housing further being formed with a second projecting portion (21) and with a third projecting portion (15), the third projecting portion being provided with an aperture receiving a hinge pin; adjusting means (27, 28) acting between the first and second projecting portions and threadingly engaging with one thereof, the adjusting means, the support means, and the hinge housing being configured such that rotation of the adjusting means in one direction causes movement of the hinge housing relative to the support means in a first direction and such that rotation of the adjusting means in the other direction causes movement of the hinge housing relative to the support means in a second direction opposite to the first direction; and hinge arm adjusting means (31) threadingly mounted in the third projecting portion such that rotation of the adjusting means in one direction moves the adjusting means in a third direction and rotation of the adjusting means in the other direction moves the adjusting means in a fourth direction opposite to the third direction, the hinge arm adjusting means being adapted to engage with a hinge arm (37) mounted in use on the hinge pin so as to raise or lower the height of the hinge arm within the hinge housing, the third and fourth directions being perpendicular to the first and second directions.

2. A hinge assembly as claimed in claim 1, wherein the support means (1) is provided with a plurality of apertures (3) for the passage of securing means.

3. (canceled)

4. (canceled)

5. A hinge assembly as claimed in claim 1, wherein the first projecting portion (5) of the support means (1) comprises two laterally spaced projections.

6. (canceled)

7. A hinge assembly as claimed in claim 5, wherein the two laterally spaced projections (5) are in the form of two bars, the bars (5) include flat portions which in use extend vertically and are opposed to and extend parallel to each other, the bars being spaced horizontally relative to each other.

8. A hinge assembly as claimed in claim 1, wherein the base plate (11) of the hinge housing (9) is formed with a plurality of slotted apertures (13) to allow for the passage of securing means while permitting lateral adjustment of the housing relative to the securing means.

9. (canceled)

10. A hinge assembly as claimed in claim 8, wherein the support means (1) is provided with a plurality of apertures (3) for the passage of securing means, and wherein the slotted apertures (13) each coincide with a respective one of the apertures (3) of the support means (1) while allowing lateral movement of the hinge housing (9) relative to the support means.

11. A hinge assembly as claimed in claim 1, wherein the second projecting portion (21) of the hinge housing (9) comprises two spaced projecting portions.

12. A hinge assembly as claimed in claim 1, wherein the adjusting means (31) comprises a bolt threaded through apertures in one of the first projecting portion (5) of the support means (1) and the second projecting portion (21) of the housing (9), wherein the bolt (31) is threaded through apertures through the second projecting portion (21) of the housing (9) and engages against the first projecting portion (5) of the support means (1).

13. (canceled)

14. A hinge assembly as claimed in claim 11, wherein the two spaced projecting portions (21) of the hinge housing (9) comprise two spaced side plates which extend vertically in use, wherein the two spaced side plates (21) extend from opposing side edges of the base plate (11).

15. (canceled)

16. A hinge assembly as claimed in claim 1, wherein the third projecting portion comprises two spaced projecting portions, the two projecting portions being positioned spaced one above the other in use.

17. A hinge assembly as claimed in claim 16, wherein the two projections forming the third projecting portion are provided with coaxial apertures receiving the hinge pin, the axial direction of the apertures in the first and second projecting portions being perpendicular to the axial direction of the apertures in the projecting portions of the third projecting portion.

18. A hinge assembly as claimed in claim 16, wherein the projecting portions of the third projecting portion comprise two hinge pin support plates which extend horizontally in use from the base plate, one above the other and spaced apart by a sufficient distance so as to be spaced above and below the aperture for the first projecting portion.

19. A hinge assembly as claimed in claim 18, wherein a spacer plate extends vertically in use between the two hinge pin support plates and is secured to each of the support plates, wherein the spacer plate is positioned a sufficient distance from the base plate to be located in use beyond the end of the first projecting portion.

20. (canceled)

21. A hinge assembly as claimed in claim 18, wherein the second projecting portion of the hinge housing comprises two spaced side plates which extend vertically in use and wherein the side plates of the hinge housing extend above and below the hinge pin support plates and are formed with cut-outs located between the support plates and extending rearwardly from free edges of the side plates to the spacer plate.

22. A hinge assembly as claimed in claim 21, wherein the side plates are secured to the edges of the hinge pin support plates and to the spacer plate.

23. A hinge assembly as claimed in claim 21, wherein the side plates are each formed with an aperture for receiving the adjusting means, the apertures in the side plates being coaxial with the aperture in the first projecting portion.

24. A hinge assembly as claimed in claim 1, wherein the hinge pin has a head which bears against the upper surface of the upper support plate and in its lower region extends through the hinge arm adjusting means.

25. A hinge assembly as claimed in claim 18, wherein rotation of the hinge arm adjusting means in the lower hinge pin support plate raises or lowers an upper annular surface of the hinge arm adjusting means, depending on the direction of rotation, in the space between the two hinge pin support plates.

26. A hinge assembly as claimed in claim 18, wherein the hinge pin is mounted in the upper support plate by way of a bearing and is mounted in the hinge pin adjusting means by way of a further bearing.

27. (canceled)

28. A hinge assembly as claimed in claim 1, wherein the hinge housing is provided with upper and lower cover plates.
